(19) United States
(12) Patent Application Publication
(10) Pub. No.: US 2025/0252265 A1
(43) Pub. Date: Aug. 7, 2025

(54) GENERATING ANSWERS TO CONTEXTUAL QUERIES WITHIN A CLOSED DOMAIN

(71) Applicant: Adobe Inc., San Jose, CA (US)

(72) Inventors: Varun Kumar Kotte, San Jose, CA (US); Trung Bui, San Jose, CA (US); Seunghyun Yoon, Seoul (KR); Sanat Sharma, Austin, TX (US); Franck Dernoncourt, Seattle, WA (US); Dewang Sultania, Emeryville, CA (US)

(21) Appl. No.: 18/432,938

(22) Filed: Feb. 5, 2024

(51) Int. Cl. G06F 40/35; G06F 40/284

(52) U.S. Cl. CPC G06F 40/35; G06F 40/284

(57) ABSTRACT

The present disclosure is directed toward systems, methods, and non-transitory computer readable media that provide a contextual query answering system that trains and implements a unique machine learning architecture to generate accurate domain-specific contextual responses. For example, the disclosed systems receive a contextual query indicating a software context of a computer application within a software-specific domain. The disclosed systems utilize a context retrieval model to generate query embeddings from the contextual query and data segment embeddings from data segments of stored digital documents. Further, the context retrieval model determines relevant digital documents from among the stored digital documents based on comparing the query embeddings and the data segment embeddings. The disclosed systems provide the relevant digital documents to a response generator model to generate a contextual response within the software-specific domain.

### BACKGROUND

Advancements in computing devices and computing systems have led to an array of specialized generative machine learning models, such as large language models, each with unique capabilities and features. For example, some large language models have been developed to generate responses to natural language prompts, ranging from single-phrase answers to more complex sets of instructions for performing a particular process. To facilitate such functionality, existing large language models are trained using vast amounts of data spanning thousands of topics and disciplines. Due to the generic nature of digital content used to train existing generative models, however, many such models exhibit deficiencies regarding flexibility, accuracy, and computational efficiency, especially when generating context-specific responses for particular software domains.

### SUMMARY

One or more embodiments provide benefits and/or solve one or more of the foregoing or other problems in the art with systems, methods, and non-transitory computer readable storage media by providing a contextual query answering system that trains and implements a unique machine learning architecture to generate accurate domain-specific contextual answers. In one or more embodiments, the disclosed systems train and utilize a context retrieval machine learning model to determine relevant contextual data for a contextual query. Furthermore, in some cases, the disclosed systems provide the relevant contextual data to a response generator machine learning model to generate accurate contextual responses specific to the software domain at hand. In one or more embodiments, the disclosed system generates the contextual responses in the form of domain-specific answers to questions and/or step-by-step instructions for in-application interaction. By integrating contextual data, the disclosed systems produce responses that are highly relevant to the user query, ensuring that the provided information is directly applicable to the software-specific domain.

### BRIEF DESCRIPTION OF THE DRAWINGS

This disclosure will describe one or more example embodiments of the systems and methods with additional specificity and detail by referencing the accompanying figures. The following paragraphs briefly describe those figures, in which:

FIG. 1 illustrates a schematic diagram of an example environment of a contextual query answering system in accordance with one or more embodiments;

FIG. 2 illustrates an example overview of using a contextual query answering system to generate a contextual response to a contextual query in accordance with one or more embodiments;

FIG. 3 illustrates an example of generating and storing vector embeddings from digital content in accordance with one or more embodiments;

FIG. 4A illustrates an example of determining relevant digital documents for a contextual query in accordance with one or more embodiments;

FIG. 4B illustrates a qualitative example of query responses generated from a contextual query utilizing the context mapping model in accordance with one or more embodiments;

FIG. 5 illustrates an example of training a context retrieval model utilizing contrastive learning in accordance with one or more embodiments;

FIG. 6 illustrates utilizing a response generator model to generate a contextual response in accordance with one or more embodiments;

FIG. 7 illustrates training a response generator model in accordance with one or more embodiments;

FIGS. 8A-8B illustrate qualitative examples of query responses generated from a contextual query in accordance with one or more embodiments;

FIG. 9 illustrates a schematic diagram of a contextual query answering system in accordance with one or more embodiments;

FIG. 10 illustrates a flowchart of a series of acts for generating a contextual response in accordance with one or more embodiments;

FIG. 11 illustrates a flowchart of a series of acts of a contextual query answering system modifying the parameters of machine learning models in accordance with one or more embodiments; and

FIG. 12 illustrates a block diagram of an example computing device in accordance with one or more embodiments.

### DETAILED DESCRIPTION

This disclosure describes one or more embodiments that utilize a contextual query answering system to train and implement machine learning models (e.g., large language models) to provide accurate domain-specific contextual answers for software applications. In many scenarios, client devices interact with large language models to request information relating to a specific computer application, such as instructions for performing a particular operation (e.g., removing unwanted objects in a digital image) and/or generating an explanation of a complicated process within the application (e.g., performing a multi-step digital video editing operation). To provide accurate, actionable responses to such software-context-dependent queries, the contextual query answering system trains and utilizes a unique machine learning architecture that includes a context retrieval model, a response generator model, and other architectural components described herein.

As just mentioned, in one or more embodiments, the contextual query answering system trains and utilizes a context retrieval model. For example, the contextual query answering system trains and utilizes a context retrieval model to retrieve or identify relevant contextual data associated with a software-specific domain (e.g., a domain pertinent to a query). For example, the contextual query answering system trains and utilizes the context retrieval model to retrieve digital data that corresponds to one or more software applications from among stored digital documents that include help documents, community question records, and help videos. As part of determining relevant software contexts, in some cases, the contextual query answering system generates or extracts data segments (e.g., portions of digital content items, such as question-answer pairs, document titles, and/or document descriptions) from stored digital documents (e.g., help documents, community question records, and/or help videos) to use as context for generating responses to queries. For instance, the contextual query answering system trains and utilizes the context retrieval model to generate and compare embeddings from contextual user queries and data segments to determine the relevant contextual data.

As mentioned, in some embodiments, the contextual query answering system generates and provides the contextual response utilizing a response generator model. For example, the contextual retrieval model provides relevant contextual data (e.g., data segments, relevant answers, and/or question-answer pairs) as to the response generator model. In some cases, the response generator model utilizes the contextual data to generate a contextual response. In one or more embodiments, the contextual query answering system provides relevant answers to the response generator model based on evaluating the Levenshtein distance between the data segments, the semantic similarity between the data segments, and/or the data source credibility. Indeed, in some cases, the contextual query answering system finetunes the response generator model using training data that includes sample questions, ground truth documents (including a question-answer pair), and negative documents. In one or more embodiments, based on a comparison of the predicted response to the answer from the question-answer pair, the contextual query answering system trains the model to produce responses based on accurate text sources (e.g., the ground truth documents) and avoid unreliable text sources (e.g., the negative documents). Using the model trained in this way, in one or more embodiments, the contextual query answering system generates a contextual response for the contextual query utilizing a response generator model tuned to generate context-specific responses for the domain contexts of computer applications within the software-specific domain.

In contrast to the disclosed systems, prior answer generation systems have a number of technical shortcomings with regard to flexibility, accuracy, and computational efficiency when generating context-specific responses to contextual queries. As one example, many conventional response generation systems are inflexible. For example, many conventional response generation systems are trained on large repositories of generic data which renders them unable to adapt to domain-specific content. Consequently, without the ability to integrate domain-specific content, conventional systems provide nonspecific replies that lack contextual relevance or a clear understanding of particular software applications. To illustrate, many prior systems inflexibly fail to adapt responses to the relevant aspects of a specific application context and/or a software-specific domain. Indeed, without specialized knowledge of domain-specific content, these conventional systems provide responses that are too generic to be of practical use for interacting with, or conveying specific information about, certain computer applications. Relatedly, due to the lack of domain-specific knowledge in conventional response generation systems, such systems are unable to generate effective solutions or processes for domain-specific problem-solving queries. Furthermore, without access to contextual data and specialized software-specific domain training, many conventional systems have a limited capability to learn from user device interactions and improve in accuracy and relevance over time.

In addition to inflexibility, many conventional systems also suffer from inaccuracies. In particular, without a contextual understanding of software-specific domains, conventional systems often struggle to interpret and respond accurately to queries that are ambiguous (or could have multiple interpretations) within different domains. Indeed, the overgeneralized training on generic data limits the ability of many conventional systems to delve into complex aspects of domain-related queries. Consequently, conventional systems often generate incomplete or inaccurate answers unrelated to target software domains. Such inaccuracies are made worse due to the rapid pace of software updates which outstrip the ability of conventional systems to update large language models, due at least in part to the computational expense (and time constraints) of retraining the systems from their extremely large and generic data corpuses.

Conventional systems also have a number of technical shortcomings with regard to computational efficiency when providing answers for contextual queries. For example, without the context retrieval model data to inform and refine the software-specific retrieval, the learning algorithms of many conventional systems are less efficient, requiring more computational power to process excessive amounts of data in attempts to generate relevant responses. To illustrate, partly due to providing ambiguous or unrelated responses, conventional systems often need to process a larger number of follow-up queries to clarify (or complete) inadequate initial responses. Generating such excessive numbers of responses requires an increased computational load and wastes computational resources that would otherwise be preserved. Relatedly, conventional systems that are not finetuned with contextual data operate less efficiently and consume more computational power for training and inference based on their non-specialized training datasets.

As suggested above, embodiments of the contextual query answering system provide a variety of advantages over conventional response generation systems. Indeed, in some embodiments, the contextual query answering system more flexibly, accurately, and efficiently trains and utilizes machine learning models to provide accurate domain-specific contextual answers to user questions within software-specific domains. For instance, the contextual query answering system improves operational flexibility when generating contextual responses. In contrast to conventional systems that do not address the particular nuances and technicalities of a software-specific domain, embodiments of the contextual query answering system generate responses that are highly relevant to the contextual query, ensuring that the provided information is directly applicable to the software-specific domain. Furthermore, embodiments of the contextual query answering system flexibly tailors responses to the software-specific domain and provide relevant contextual answers to troubleshoot issues or provide step-by-step guidance for related to software-specific applications. Furthermore, with access to contextual data and specialized training, in one or more embodiments, the contextual query answering system learns from user device interactions to provide contextual answers that improve in accuracy and relevance to the software-specific domain. In addition, given its context-aware capabilities, embodiments of the contextual query answering system are better equipped to handle ambiguous or complex queries than conventional systems. Indeed, embodiments of the contextual query answering system flexibly interpret and respond to ambiguous or complex queries based on its customization to the software-specific domain.

Furthermore, in one or more embodiments, the contextual query answering system provides improved accuracy. For example, the contextual query answering system handles ambiguous or complex queries better than conventional systems, more accurately interpreting contextual queries within the software-specific domain even when the contextual queries are ambiguous or poorly structured. Relatedly, unlike many conventional systems that a lack depth of specialized knowledge within the software-specific domain, embodiments of the contextual query answering system provide precise and detailed information for complex or technical scenarios within the software-specific domain. Furthermore, unlike many conventional systems that do not have access to up-to-date software-specific information, embodiments of the contextual query answering system provide up-to-date and accurate responses that are targeted to particular software domains and based on the latest available software-specific information. Indeed, by generating a specialized and targeted dataset using a context retrieval model, embodiments of the contextual query answering system provide accurate, relevant responses in view of continuous advancements within fast-changing software domains. Additionally, experimenters have demonstrated that, due to its unique architecture of context retrieval and response generation models, embodiments of the contextual query answering system reduce hallucinations compared to other large language model-based systems.

In addition, embodiments of the contextual query answering system provides improved computational efficiency. For example, unlike conventional systems that repeatedly process generic data for different queries, embodiments of the contextual query answering system more efficiently retrieve and process relevant contextual information, avoiding the computational overhead of sifting through large volumes of irrelevant data. For example, unlike conventional systems that need to process a larger number of follow-up queries to clarify or elaborate upon an inadequate initial response, the contextual query answering system utilizes the domain-specific context (determined via a context retrieval model) to interpret queries more accurately on the initial attempt, removing the computational load required for additional clarifying queries. Furthermore, embodiments of the contextual query answering system are fine-tuned through the incorporation of contextual and domain-specific content to generate relevant contextual responses more efficiently. As a result, embodiments of the contextual query answering system provide a marked reduction in the computational resources required-such as processing time and memory allocation-leading to lower energy demands, more conservative use of hardware resources, and reduced environmental impact.

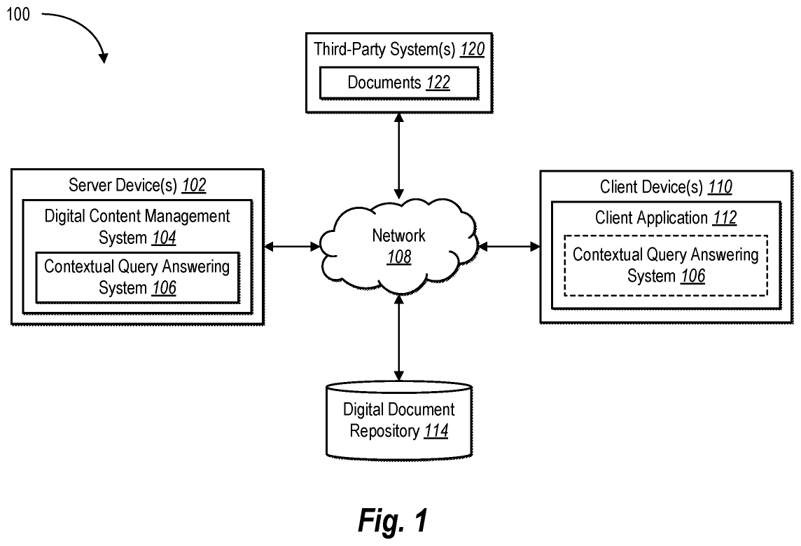

Additional detail regarding the contextual query answering system will now be provided with reference to the figures. For example, FIG. 1 illustrates a schematic diagram of an exemplary system environment (“environment”) 100 in which a contextual query answering system 106 operates. As illustrated in FIG. 1, the environment 100 includes server device(s) 102, a network 108, and client device(s) 110.

Although the environment 100 of FIG. 1 is depicted as having a particular number of components, the environment 100 is capable of having any number of additional or alternative components (e.g., any number of servers, client devices, or other components in communication with the contextual query answering system 106 via the network 108). Similarly, although FIG. 1 illustrates a particular arrangement of the server device(s) 102, the network 108, client device(s) 110, digital document repository 114, and third-party system(s) 120, various additional arrangements are possible.

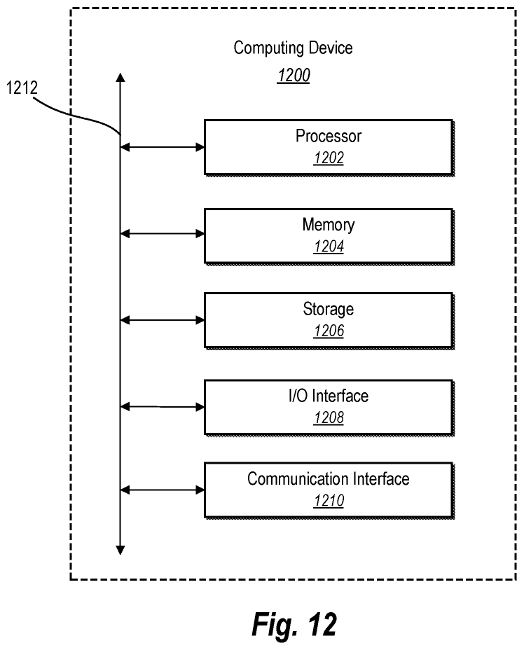

The server device(s) 102, the network 108, client device(s) 110, and third-party system(s) 120, are communicatively coupled with each other either directly or indirectly (e.g., through the network 108 discussed in greater detail below in relation to FIG. 12). Moreover, the server device(s) 102, client device(s) 110, and third-party system(s) 120 include one of a variety of computing devices (including one or more computing devices as discussed in greater detail with relation to FIG. 12).

As illustrated in FIG. 1, the environment 100 includes the digital content management system 104. The digital content management system 104 generates, tracks, stores, processes, receives, and transmits electronic data, including contextual queries, digital content, vector embeddings, and contextual responses. For example, the digital content management system 104 receives or monitors interactions across the client device(s) 110. In some embodiments, the digital content management system 104 transmits content to the client device(s) 110 to cause the client device(s) 110 to display content associated with contextual queries. For example, the digital content management system 104 receives contextual queries and provide contextual responses to client device(s) 110 corresponding to system need (e.g., provide a query prompt for display via client application(s) 112).

Additionally, the digital content management system 104 includes all, or a portion of, the contextual query answering system 106. For example, the contextual query answering system 106 operates on the server device(s) 102 to access digital content (including help documents, community question records, and help videos), determine digital content changes, and provide localization of content changes to the client device(s) 110. In one or more embodiments, via the server device(s) 102, the contextual query answering system 106 generates and displays contextual query responses based on the use of a context retrieval model and a response generator model. Example components of the contextual query answering system 106 will be described below with regard to FIG. 12.

Furthermore, as shown in FIG. 1, the illustrated system includes the client device(s) 110. In some embodiments, the client device(s) 110 include, but are not limited to, mobile devices (e.g., smartphones, tablets), laptop computers, desktop computers, or another type of computing devices, including those explained below in reference to FIG. 12. Some embodiments of client device(s) 110 are operated by a user to perform a variety of functions via respective client application(s) 112 such as the generation and presentation of contextual responses. The client device(s) 110 include one or more applications (e.g., the client application(s) 112) that access, edit, modify, store, and/or provide, for display, digital content. For example, in some embodiments, the client application(s) 112 include a software application and/or the contextual query answering system 106 installed on the client device(s) 110. In other cases, however, the client application(s) 112 include a web browser or other application that accesses a software application hosted on the server device(s) 102.

The contextual query answering system 106 can be implemented in whole, or in part, by the individual elements of the environment 100. Indeed, as shown in FIG. 1 the contextual query answering system 106 can be implemented with regard to the server device(s) 102 and/or the client device(s) 110. In particular embodiments, the contextual query answering system 106 on the client device(s) 110 comprises a web application, a native application installed on the client device(s) 110 (e.g., a mobile application, a desktop application, a plug-in application, etc.), or a cloud-based application where part of the functionality is performed by the server device(s) 102.

In additional or alternative embodiments, the contextual query answering system 106 on the client device(s) 110 represents and/or provides the same or similar functionality as described herein in connection with the contextual query answering system 106 on the server device(s) 102. In some embodiments, the contextual query answering system 106 on the server device(s) 102 supports the contextual query answering system 106 on the client device(s) 110.

In some embodiments, the contextual query answering system 106 includes a web hosting application that allows the client device(s) 110 to interact with content and services hosted on the server device(s) 102. To illustrate, in one or more embodiments, the client device(s) 110 accesses a web page or computing application supported by the server device(s) 102. The client device(s) 110 provides input to the server device(s) 102 (e.g., selected content items). In response, the contextual query answering system 106 on the server device(s) 102 generates/modifies digital content. The server device(s) 102 then provides the digital content to the client device(s) 110.

In some embodiments, the contextual query answering system 106 includes the third-party system(s) 120 and the documents 122. To illustrate, in one or more embodiments, the contextual query answering system 106 interacts with content and services hosted on the third-party system(s). To illustrate, in one or more embodiments, the contextual query answering system 106 accesses a web page or computing application supported by the third-party system(s) 120. The third-party system(s) 120 provide input to the contextual query answering system 106 (e.g., contextual queries) and documents 122 (e.g., help documents, community question records, and help video transcripts). In response, the contextual query answering system 106 generates/modifies digital content including generating contextual responses. The contextual query answering system 106 then provides the digital content to the third-party system(s) 120.

In one or more embodiments, the client device(s) 110 and the server device(s) 102 work together to implement the contextual query answering system 106. For example, in some embodiments, the server device(s) 102 train one or more machine learning models (e.g., encoders, context retrieval models, response generator models, and/or question-answer generator models), such as neural networks, and provide the one or more trained machine learning models to the client device(s) 110 for implementation. In some embodiments, the server device(s) 102 train one or more models (e.g., neural networks) together with the client device(s) 110.

In some embodiments, though not illustrated in FIG. 1, the environment 100 has a different arrangement of components and/or has a different number or set of components altogether. For example, in certain embodiments, the client device(s) 110 communicate directly with the server device(s) 102, bypassing the network 108. As another example, the environment 100 includes a third-party server comprising a content server and/or a data collection server.

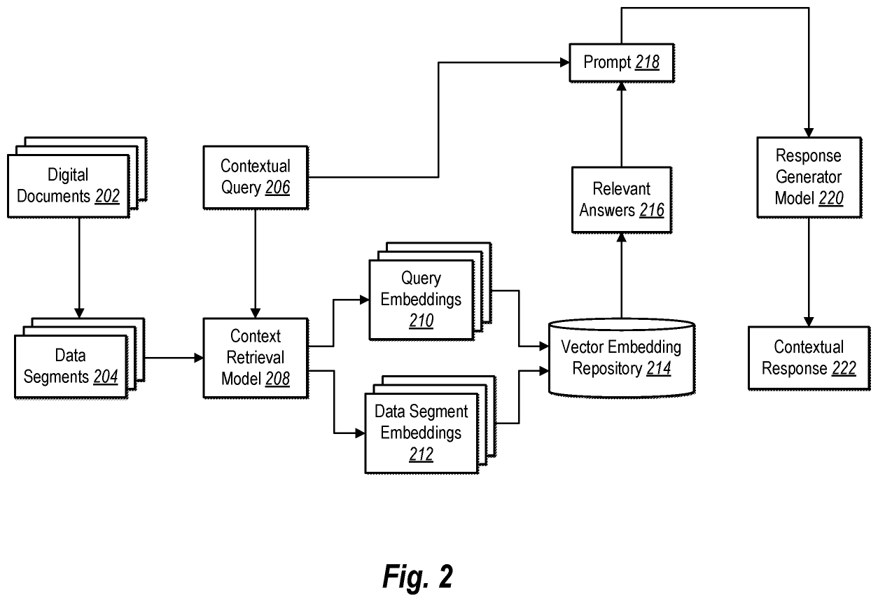

As previously mentioned, in one or more embodiments, the contextual query answering system 106 utilizes a contextual query answering system to train and implement machine learning models (e.g., large language models) to provide accurate domain-specific contextual answers for software applications. In particular, the contextual query answering system 106 utilizes a specific combination of machine learning models to generate a contextual response. FIG. 2 illustrates an example overview of using a contextual query answering system to generate a contextual response to a contextual query in accordance with one or more embodiments. Additional detail regarding the various acts of FIG. 2 is provided thereafter with reference to subsequent figures.

As shown, the contextual query answering system 106 receives a contextual query that includes terminology indicating a software context of a computer application. For example, a contextual query (received from a client device) includes a query that incorporates, either expressly or impliedly, terms or phrases specific to the functionality or features of a process, an operation, or an application in a software-specific domain. To illustrate, asking “How do I change the opacity for a layer?” implies a need for instructions on changing the opacity within a particular application within a software-specific domain

As shown, the contextual query answering system 106 identifies or receives digital documents 202. Specifically, the contextual query answering system 106 identifies digital documents 202 (e.g., help documents, community question records, and/or help videos) stored in one or more databases and pertaining to various software contexts, applications, or domains. As also shown, the contextual query answering system 106 generates data segments 204 from the digital documents 202. In particular, the contextual query answering system 106 divides the digital documents 202 into sub-parts or segments (having a particular token length or character length) for use by a context retrieval model 208. In certain embodiments, the data segments 204 include a representation of one or more of the digital documents 202 containing a specified number of tokens. For example, the data segments 204 include a specified number of tokens or at least a threshold number of tokens. In some cases, each data segment includes the same number of tokens (including characters and spaces), while in other cases, different data segments have different lengths or different numbers of tokens.

As shown, the contextual query answering system 106 generates data segments 204 (e.g., representing question-answer pairs, document titles and/or document descriptions) from digital documents 202 as input for the context retrieval model 208. As shown in FIG. 2, the contextual query answering system 106 utilizes the large language models (e.g., the context retrieval model 208 and the response generator model 220) to process the contextual query 206 in combination with the digital documents 202. In some embodiments, a large language model includes or refers to a machine learning model trained to perform computer tasks to generate or identify content items in response to trigger events (e.g., user interactions, such as text queries and button selections). For instance, a large language model is a neural network (e.g., a deep neural network) with many parameters trained on large quantities of data (e.g., unlabeled text) using a particular learning technique (e.g., self-supervised learning). In some cases, a large language model includes parameters trained to generate model outputs (e.g., content items, summaries, or query responses) and/or to identify content items based on various contextual data, including graph information from a knowledge graph and/or historical user account behavior.

Relatedly, in certain embodiments, a machine learning model includes or refers to a computer algorithm or a collection of computer algorithms that automatically improve for a particular task through iterative outputs or predictions based on the use of data. For example, a machine learning model utilizes one or more learning techniques to improve accuracy and/or effectiveness. Example machine learning models include various types of neural networks, decision trees, support vector machines, linear regression models, and Bayesian networks. In some embodiments, the morphing interface system utilizes a large language machine-learning model in the form of a neural network.

Along these lines, a neural network includes or refers to a machine learning model that is trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., content items or smart topic outputs) based on a plurality of inputs provided to the neural network. In some cases, a neural network refers to an algorithm (or set of algorithms) that implements deep learning techniques to model high-level abstractions in data. In certain embodiments, a neural network includes various layers, such as an input layer, one or more hidden layers, and an output layer that each perform tasks for processing data. For example, a neural network includes a deep neural network, a convolutional neural network, a transformer neural network, a recurrent neural network (e.g., an LSTM), a graph neural network, or a generative adversarial neural network. Upon training, in some instances, a neural network becomes a large language model.

As shown in FIG. 2, the context retrieval model 208 is a machine learning model (e.g., a neural network) or a collection of machine learning models for generating or encoding query embeddings 210 from the contextual query 206 to represent the semantic content of the contextual query 206. Further, the context retrieval model 208 generates data segment embeddings 212 from the data segments 204 to represent the semantic content of data segments 204. The query embeddings 210 and the data segment embeddings 212 include token-specific embeddings (e.g., latent vectors) of the data segments 204. For example, the query embeddings 210 and the data segment embeddings 212 refer to latent embeddings, such as mathematical or computerized representations of text segments in an embedding space, interpretable by machine learning models (e.g., the context retrieval model 208 and/or the response generator model 220). By transforming the contextual query 206 and the data segments 204 into embeddings, the contextual query answering system 106 converts the digital data into an analogous format utilized (e.g., compared to determine relevance) to determine data sources for generating the contextual response 222.

As shown, the contextual query answering system 106 utilizes a vector embedding repository 214 to organize and store the data segment embeddings 212. In particular, based on the contextual query 206, the contextual query answering system 106 utilizes geometric properties of the vector space (such as distance and direction) to perform a similarity search of the vector embedding repository 314 to retrieve relevant answers 216 for the prompt 218. To illustrate, the contextual query answering system 106 utilizes the vector embedding repository 214 to compare embeddings in the embedding space and determine to data segment embeddings 212 within a threshold distance of the query embeddings 210. By utilizing the vector embedding repository 204, the contextual query answering system 106 to quickly retrieves the vector representation of the data segment embeddings 212 for the prompt 218.

In certain embodiments, the contextual query answering system 106 trains the context retrieval model 208 to determine semantic representations for both the data segments 204 and the contextual query 206 utilizing contrastive learning. Furthermore, the context retrieval model 208 utilizes the query embeddings 210 and the data segment embeddings 212 to determine relevant contextual data that pertains to the contextual query 206 within the software-specific domain. In some embodiments, the context retrieval model 208 determines a cosine similarity between the query embeddings 210 and the data segment embeddings 212 to retrieve the relevant answers 216 for the contextual query 206.

In some embodiments, the contextual query answering system 106 selects relevant answers 216 (and other relevant contextual data segments) from the vector embedding repository 214 to generate the prompt 218. In some embodiments, the contextual query answering system 106 performs a similarity search to determine the relevant answers 216. For example, the contextual query answering system 106 determines a cosine similarity between the query embeddings 210 and the vector embedding repository 214 and selects the top-k answers to generate the relevant answers 216. The contextual query answering system 106 thus generates the prompt 218 to include the relevant answers 216 (and other relevant contextual data segments) and to include text instructions for the response generator model 220 to generate a contextual response 222.

As further shown in FIG. 2, the contextual query answering system 106 provides the prompt 218 to the response generator model 220 to generate the contextual response 222. The response generator model 220 refers to a model (e.g., a machine learning model) or a collection of models for generating a contextual response 222 for a contextual query 206 from a prompt 218. In one or more embodiments, the contextual query answering system 106 utilizes a combination of the contextual query 206, content from the digital documents 202, and contextual learning to generate the prompt 218. Based on the prompt 218, the response generator model 220 generates the contextual response 222 as a set of instructions, operations, processes, and/or descriptions specifically relating to a certain software application or context within the software-specific domain. For instance, if the software-specific domain includes Adobe Photoshop, and the contextual query 206 is about how to adjust brightness within a photo editing tool, the contextual response 222 would include step-by-step instructions within the context of the Adobe Photoshop interface and functionality. Notably, the contextual query answering system 106 utilizes a combination of both the context retrieval model 208 to provide inputs to the response generator model 220 and the response generator model 220 to generate the contextual response 222.

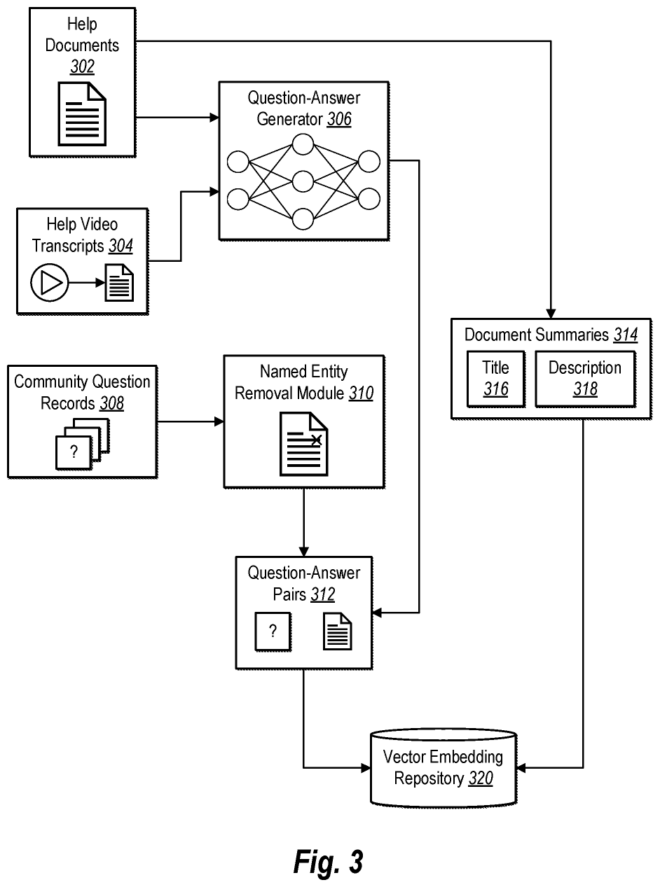

As mentioned, the contextual query answering system 106 trains and utilizes the context retrieval model to retrieve digital data that corresponds to one or more software applications of a software-specific domain from among stored digital documents that include help documents, community question records, and help video transcripts. Further, the contextual query answering system 106 utilizes embeddings to determine relevant digital content in response to a contextual query. FIG. 3 illustrates an example of generating and storing vector embeddings from digital content in accordance with one or more embodiments.

As shown in FIG. 3, the contextual query answering system 106 retrieves and utilizes digital content from a diverse retrieval set. For example, the contextual query answering system 106 utilizes primary sources such as help documents (e.g., help documents 302, title 316, description 318) and community question records 308. In addition, the contextual query answering system 106 generates and utilizes derived datasets (e.g., datasets derived from other sources) such as the question-answer pairs 312 obtained from help documents 302 and help video transcripts 304 (e.g., such as the Adobe Care YouTube channel).

As shown in FIG. 3, the contextual query answering system 106 retrieves and utilizes digital content from help documents 302. For example, the contextual query answering system 106 retrieves digital content from the help documents 302 that include product-specific software information such as product feature descriptions, product usage suggestions, installation instructions, and troubleshooting steps. In one or more embodiments, the help documents 302 include document titles and descriptions that represent or summarize the content of the documents. To illustrate, the help documents 302 include a 20-page document that is represented by a 20-word title describing the document and a 50-word summary that summarizes the document content. Notably, the contextual query answering system 106 utilize help documents 302 not limited to a specific size for the document, title, or summary.

As also illustrated in FIG. 3, the contextual query answering system 106 generates or retrieves the document summaries 314 from the help documents 302. In some embodiments, the contextual query answering system 106 generates document summaries 314 that include a title 316 and a description 318. For example, the contextual query answering system 106 employs a large language model (LLM) to analyze the content of the help documents 302 and to generate concise and informative titles and descriptive summaries that encapsulate the main points of the help documents 302. Specifically, the large language model generate a title 316 and a description 318 for the each of the help documents 302. Based on the generation of the title 316 and the description 318, the contextual query answering system 106 uses an encoder to transform the title 316 and the description 318 into embeddings in an embedding space. As shown, the contextual query answering system 106 stores embeddings for the document summaries 314 in the vector embedding repository 320.

As shown, in one or more embodiments, the contextual query answering system 106 utilizes a question-answer generator 306. In particular, the contextual query answering system 106 generates question-answer pairs 312 utilizing datasets generated from the help documents 302, the help video transcripts 304, and/or the community question records 308. For example, the contextual query answering system 106 utilizes a question-answer generator 306 to generate the question-answer pairs 312 from the help documents 302 and/or the help video transcripts 304. In some embodiments, the contextual query answering system 106 generates multiple question-answer pairs from each of the help documents 302 and/or help video transcripts 304 using the question-answer generator 306 which incorporates a large language model.

In one or more embodiments, the question-answer generator 306 includes or refers to a model (e.g., a machine learning model) or a collection of models for extracting question-answer pairs from digital content. For example, the question-answer generator 306 analyzes and parses large volumes of text-based data to identify and extract topics that encapsulate question-answer pairs based on subjects discussed within the content. For example, the question-answer generator 306 identifies potential questions a user might ask based on the content of the input (e.g., help documents 302 and/or help video transcripts 304). Further, the question-answer generator 306 formulates answers to these questions by extracting relevant segments of text. In certain embodiments, the question-answer generator 306 is trained to recognize patterns in how the questions are framed and answered in instructional material, which allows it to generate accurate and informative question-answer pairs.

In some embodiments, the contextual query answering system 106 generates video textual content representing the digital content in help videos (e.g., visual, sound, spoken) to create the help video transcripts 304. As also shown, the contextual query answering system 106 generates question answer pairs from the help video transcripts 304. In particular, the contextual query answering system 106 generates a transcript from a help video (e.g., a tutorial video of how to perform an operation or a set of processes in a particular application). For example, the question-answer generator 306 parses the help video transcripts 304 to identify sections where a user is likely to have questions-such as when a new step in a process is introduced or a new term is used. The question-answer generator 306 generates these potential queries as questions. The question-answer generator 306 further determines corresponding answers within the help video transcript 304 by determining portions of the text that explain the steps or concepts.

In certain embodiments, the contextual query answering system 106 utilizes few-shot learning techniques to train the question-answer generator 306 during a pre-processing phase. To illustrate, the contextual query answering system 106 prepends a set of sample help documents or sample help video transcripts in combination with generated question-answer pairs with each call to the question-answer generator 306. In this way, the contextual query answering system 106 guides the question-answer generator 306 to generate a desired style and quality for the answer. By using few-shot learning, the contextual query answering system 106 significantly reduces computational costs and resources compared to conventional systems that require large and diverse datasets to achieve similar levels of generalization.

To illustrate, the contextual query answering system 106 provides specialized prompts (and few-shot learning) to guide the training of the question-answer generator 306. In some embodiments, the contextual query answering system 106 guides the question-answer generator 306 to understand the context and structure of the questions based on the specialized product-specific training data. Furthermore, in one or more embodiments, the contextual query answering system 106 trains the question-answer generator 306 to provide step-wise answers for the question-answer pairs 312. As an example, the contextual query answering system 106 provides the following prompt to generate the question-answer pairs:

Prompt: You are an AI assistant that helps create question-answer pairs. You start every
question with QUESTION and every answer with ANSWER. Answer in detail.

In response to this prompt, the question-answer generator 306 generates the following question-answer pair:

QUESTION: What are the steps to adjust the brightness, contrast, and color in your video
clips using the Adjusting Brightness, Contrast, and Color Guided Edit in Adobe Premiere
Elements?
ANSWER:
1. Click Add media to import the video clip you want to enhance.
2. Select Guided > Adjusting Brightness + Contrast & Color.
3. To adjust your video clip, select it.
4. Click the Adjust panel to adjust selected settings.
5. Click Lighting to adjust the brightness and contrast.
6. Click a thumbnail in the grid of the adjustments panel to preview the change in
brightness.
7. Click More and drag the sliders for more precise adjustment.
8. Click Color in the adjustments panel to open the Color section.
9. You can adjust the hue, lightness, saturation, and vibrance in the Color tab.
10. Click a thumbnail in the grid to preview the change.

As further shown in FIG. 3, the contextual query answering system 106 utilizes community question records 308 to generate the question-answer pairs 312. For example, the contextual query answering system 106 utilizes questions and answers generated by a user community regarding specific products within the software-specific domain. To illustrate, the community question records 308 include a corpus of real-world problems and solutions encountered, troubleshooted, solved, and digitally documented by users regarding software contexts in the software-specific domain. The community question records 308 include user interactions with specific products, follow-up questions regarding products, proposed answers related to products, or user methods for using products.

In one or more embodiments, the contextual query answering system 106 utilizes a named entity removal module 310 (NER) to sanitize the community question records 308. In particular, the named entity removal module 310 performs de-identification by removing classes of personally identifiable information (PII) from the content of the community question records 308. Further, the named entity removal module 310 replaces removed content with sanitized text.

In one or more embodiments, the named entity removal module 310 utilizes a dual-layered named entity recognition strategy. For example, the named entity removal module 310 integrates an NER model (e.g., the en_core_web_lg model described in https://github.com/explosion/spacy-models/blob/master/meta/en_core_web_lg-2.2.5.json) that is pre-trained on a large textual corpus and employs a deep learning architecture, enabling the efficient categorization of ‘PERSON’-type entities with a high degree of accuracy. Augmenting the machine learning-based NER, the named entity removal module 310 utilizes a custom function (“custom_removal”) to recognize and eliminate non-standard or pattern-based text segments such as textual patterns, email formats, and signature lines. In some cases, the custom function also includes other recognition patterns such as those used for phone number sanitization based on conforming to various international formats.

In one or more embodiments, the named entity removal module 310 integrates iteratively with the contextual query answering system 106. In particular, the named entity removal module 310 operates iteratively over the community question records 308, which are ingested by the contextual query answering system 106 in a JSON-based serialized format. The named entity removal module 310 processes each entry through the dual-layered NER, and the sanitized text replaces the original content inline, thus ensuring data integrity while enhancing privacy within the contextual query answering system 106. By utilizing a serialized output, the named entity removal module 310 seamlessly integrates into the instances of the question-answer pairs 312.

In some embodiments, the contextual query answering system 106 generates a dataset to store within the vector embedding repository 320. Indeed, the contextual query answering system 106 extracts embeddings from help documents 302, help video transcripts 304, and community question records 308 to store in the vector embedding repository. As an example, the contextual query answering system 106 generates a dataset of 121,547 items to generate the question-answer pairs 312 utilizing the help documents 302, help video transcripts 304, and community question records 308 as follows:

| QA Pair Source | Num Rows | QA Pair % |
|---|---|---|
| Help Articles | 64959 | 53% |
| Community Questions | 15148 | 12.4% |
| Generated Help QA | 40909 | 33.6% |
| Generated Video QA | 531 | 0.4% |

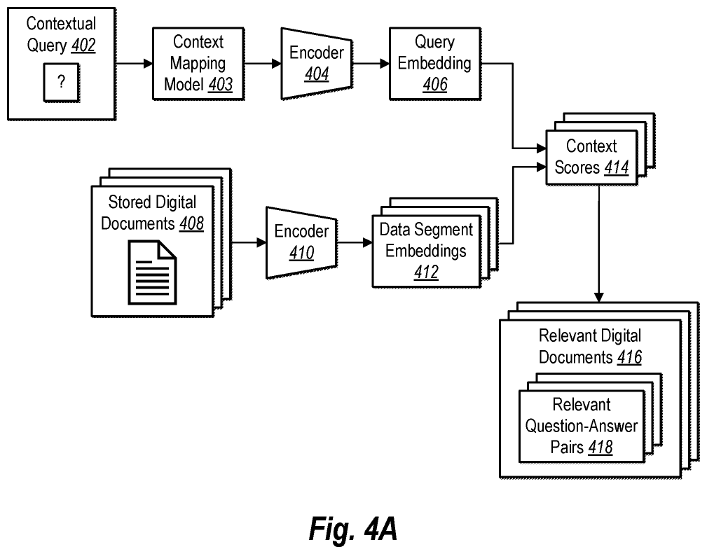

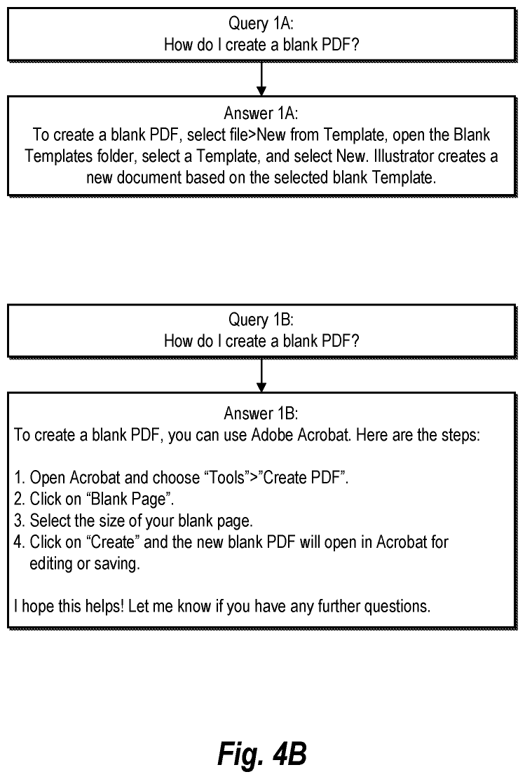

As mentioned, the contextual query answering system 106 trains a context retrieval model to determine relevant question-answer pairs for software contexts of a plurality of computer applications through a comparison of embeddings for a contextual query and digital documents. In particular, the context retrieval model includes one or more encoders for extracting embeddings and also includes comparators for comparing embeddings to identify relevant digital documents. FIG. 4A illustrates an example of determining relevant digital documents (that provide context) for a contextual query in accordance with one or more embodiments.

As shown in FIG. 4A, in one or more embodiments, the contextual query answering system 106 receives a contextual query 402. From the contextual query 402, the contextual query answering system 106 determines one or more of the relevant digital documents 416, such as relevant question-answer pairs 418. Specifically, the contextual query answering system 106 generates and compares a query embedding 406 and data segment embeddings 412 to determine relevance of stored digital documents 408.

As part of the process for determining the relevant digital documents 416, the contextual query answering system 106 cleans and prepares query segments from the contextual query 402 by removing noise (such as special characters) and standardizing text. The contextual query answering system 106 also converts the preprocessed query segments into tokens (e.g., words, subwords, characters, and/or spaces). As shown, the contextual query answering system 106 passes the tokens into the encoder 404. In one or more embodiments, the contextual query answering system 106 utilizes a pre-trained model for the encoder 404 such as BERT, Word2Vec, or a custom-trained neural network. In some cases, the encoder 404 further combines (e.g., concatenates) the individual token embeddings to form a single vector as the query embedding 406 for the contextual query 402.

In certain embodiments, the contextual query answering system 106 utilizes a context mapping model 403 to map the contextual query 402 to one or more specific products before passing the tokens into the encoder 404. The context mapping model 403 operates by taking a contextual query 402 and enriching it by additional context, thus enabling a more precise mapping to specific products or applications within the software-specific domain. For example, the contextual query answering system 106 generates, utilizing the context mapping model 403, a mapping of query terminology from the contextual query 402 to one or more computer applications. For instance, the contextual query answering system 106 employs a context mapping model 403 to translate or align the terminology used in the contextual query 402 with terms that are associated with one or more computer applications. In some cases, the context mapping model 403 generates and injects context-specific terms, such as application names, process names, operation names, and/or other domain indicators into the contextual query 402.

To illustrate, the context mapping model 403 expands abbreviations, interprets jargon, and/or associates features with product names to bridge the gap between the contextual query 402 and the technical language associated with domain-specific software products. The context mapping model 403 utilizes the context in which the terms of the contextual query 402 are used and applies domain-specific knowledge to interpret the intent behind the query more accurately. By including this context mapping model 403, the contextual query answering system 106, provides better relevancy to products for the stored digital documents 408 within the software-specific domain.

As further illustrated in FIG. 4A, as part of the process of determining the relevant digital documents 416 to provide context for the contextual query 402, the contextual query answering system 106 generates data segment embeddings 412 from the stored digital documents 408. In particular, the contextual query answering system 106 determines semantically consistent segments of the stored digital documents 408 and extracts the data segment embeddings 412 from the semantically consistent segments. In one or more embodiments, a semantically consistent segment refers to a portion of text that maintains a consistent meaning or topic throughout its length. For example, for the contextual query answering system 106 to recognize a segment as semantically consistent, the segment must discuss a particular topic for at least a predetermined number of tokens (e.g., a specific measure or threshold). To illustrate, the contextual query answering system 106 determines segments that contain at least 50 consecutive tokens discussing the same topic sufficient to establish a clear and consistent context.

Utilizing the semantically consistent segments, the contextual query answering system 106 divides content of the stored digital documents 408 into the semantically consistent segments by determining content portions associated with one or more semantic concepts. To illustrate, the contextual query answering system 106 cleans and prepares data segments from the stored digital documents 408 by removing noise (such as special characters and PII) and standardizing text. Further, the contextual query answering system 106 parses the stored digital documents 408 to extract features including keyword frequency, semantic features, named entities, topics, headings, summaries, and/or metadata. Further, the contextual query answering system 106 also converts the preprocessed data segments into tokens (e.g., words, subwords, characters) and passes the tokens into the encoder 410. In one or more embodiments, the contextual query answering system 106 utilizes a pre-trained model for the encoder 410 such as BERT, Word2Vec, or a custom-trained neural network. The encoder 410 further combines the token embeddings to form the data segment embeddings 412 for the stored digital documents 408.

As further shown in FIG. 4A, the contextual query answering system 106 performs a comparison to generate context scores 414 to determine relevant digital documents 416, such as relevant question-answer pairs 418. For example, the contextual query answering system 106 generates the context scores 414 representing a similarity (e.g., a cosine similarity or an embedding space distance) between the query embedding 406 and the data segment embeddings 412. In one or more embodiments, the contextual query answering system 106 utilizes a cosine similarity to measure the cosine of the angle between the embedding vectors to determine the relationship between the query embedding 406 and the data segment embeddings 412.

The contextual query answering system 106 ranks the stored digital documents 408 based on the context scores 414 to determine a subset of the stored digital documents 408 that are relevant digital documents 416. For example, the contextual query answering system 106 filters the stored digital documents 408 to exclude stored digital documents 408 that do not meet a threshold context score. Similarly, the contextual query answering system 106 generates relevant question-answer pairs 418 associated with the relevant digital documents 416. In particular, the contextual query answering system 106 selects relevant question-answer pairs by filtering the data segment embeddings 412 to exclude data segment embeddings 412 that do not meet a threshold based on the context scores 414.

In one or more embodiments, the contextual query answering system 106 utilizes Non-Discounted Cumulative Gain(nDCG) as an evaluation metric for the context scores 414. For example, the contextual query answering system 106 determines relevant context from document segments of the stored digital documents 408. In one or more embodiments, the document segments include associated question-answer pairs (data segment embeddings 412). Using nDCG, the contextual query answering system 106 assigns a degree of the relevance to the stored digital documents 408 and the associated question-answer pairs. To illustrate, the contextual query answering system 106 considers the position of the stored digital documents 408 in a ranked list of the stored digital documents 408. The contextual query answering system 106 assigns higher relevance scores to the stored digital documents 408 that appear at the top of the list. The contextual query answering system 106 selects only the top-k of the relevant digital documents 416 and the associated question-answer pairs for the relevant question-answer pairs 418. In turn, the relevant question-answer pairs 418 are provided as input to the response generator model.

As mentioned, by utilizing the context mapping model 403, the contextual query answering system 106, provides improved relevancy to products within the software-specific domain for the stored digital documents 408. FIG. 4B illustrates a qualitative example of query responses generated from a contextual query utilizing the context mapping model in accordance with one or more embodiments.

As shown in FIG. 4B, the context mapping model 403 determines the context in which the terms of the contextual query 402 are used and applies domain-specific knowledge to interpret the intent behind the query more accurately. For example, by utilizing the context mapping model 403, the contextual query answering system 106 generates a context-specific response to a contextual query. To illustrate, as shown in FIG. 4B by Query 1A, the contextual query answering system 106 provides a general non-contextual answer when employed without utilizing the context mapping model 403. In contrast, as shown by Query 1B, in which the contextual query answering system 106 utilizes the context mapping model 403, the contextual query answering system 106 generates a context-specific response to a contextual query.

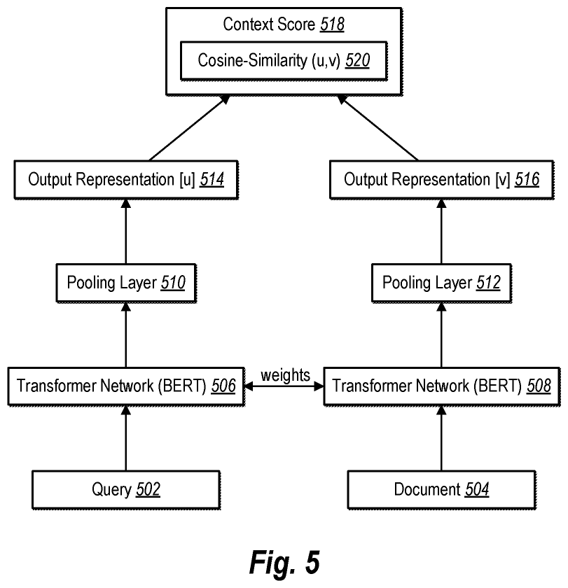

As mentioned, the contextual query answering system 106 trains the context retrieval model utilizing contrastive learning in a self-supervised manner. In particular, through contrastive learning, the contextual query answering system 106 models both queries and documents in the same representation space. FIG. 5 illustrates an example of training a context retrieval model utilizing contrastive learning in accordance with one or more embodiments.

As shown, the contextual query answering system 106 processes training data, including a query 502 and a document 504 together. For example, the contextual query answering system 106 trains the context retrieval model by feeding the query 502 and the document 504 together in a training batch to the context retrieval model. As shown, the context retrieval model passes the query 502 to transformer network 506 (e.g., BERT) and, similarly, the document 504 is passed to the transformer network 508 (e.g., BERT). In one or more embodiments, the context retrieval model utilizes transformers pretrained on the sentence similarity task (e.g., MPNet).

As shown, the contextual query answering system 106 determines shared weights between the transformer network 506 and the transformer network 508. For example, during the training process, the context retrieval model learns to align the representations of the query 502 and the document 504 by adjusting shared weights in the transformer network 506 and the transformer network 508. For example, during backpropagation, the context retrieval model utilizes the gradients calculated from the loss function to update the same weights in both the transformer network 506 and the transformer network 508, so that they learn to produce compatible representations of the query 502 and the document 504 together.

As part of the training process, in one or more embodiments, the contextual query answering system 106 assigns a weight to document 504 based on a frequency of user clicks. In particular, the contextual query answering system 106 generates a training dataset from stored user interaction logs that document how users engage with different software contexts after (or before) receiving responses to contextual queries. Moreover, the contextual query answering system 106 correlates the stored user interaction logs with the content of the stored digital documents (e.g., document 504) in relation to the contextual queries.

For example, the contextual query answering system 106 adjusts parameters of the context retrieval model using a weighted cross entropy loss function that is weighted based on a relevance metric. The relevance metric is generated based on how relevant the document 504 is to the query 502 as shown by a frequency of user selection of the document 504 for similar queries. In this way, the contextual query answering system 106 adds an inherent ranking signal inside the set of relevant documents that is derived by using the log of the click ratio of the query-document pair.

To illustrate, for a specific query where multiple documents are clicked, and the contextual query answering system 106 puts more weight on higher click pairs (e.g., query-documents pairs where the document is clicked more than others for the specific query). In particular, the contextual query answering system 106 identifies a set of digital documents selected via a client device interaction in relation to a specific query. The contextual query answering system 106 determines a relevance metric in relation to the specific query based on comparing a selection total (e.g., user interactions to access, edit, share, or otherwise interact with the document 504) of the document 504 and selection totals of other sample documents in the set of digital documents. For instance, the contextual query answering system 106 defines the relevance metric as:

$$relevance = log ( \frac{clicks ( {q}_{i} \to {d}_{j} )}{max ( clicks ( {q}_{i} \to {D}_{i} ) )} )$$

qᵢ represents the specific query,
dⱼ represents the particular document clicked,
clicks represents the number of clicks for the pair,
Dᵢ represents the set of documents clicked for
   By utilizing the log of the max click ratio, the contextual query answering system 106 allows less frequently clicked documents to have adequate representation within the training process.

As further illustrated in FIG. 5, the context retrieval model generates an output representation utilizing pooling layers. In particular, the context retrieval model generates output representation 514 and the output representation 516 (embedding vectors [u] and [v]) utilizing mean pooling. For instance, the context retrieval model utilizes the pooling layer 510 and the pooling layer 512 to convert the variable-length sequences of token embeddings into fixed-length embedding vectors [u] and [v] using the average of all token embeddings. In certain embodiments, the context retrieval model utilizes max pooling (e.g., maximum of all token embeddings) or first token pooling (e.g., first token of the sequence) to generate the output representation 514 and the output representation 516.

As shown, the contextual query answering system 106 determines a context score 518 based on the similarity between the output representation 514 and the output representation 516. In particular, the contextual query answering system 106 minimizes the mean squared error loss for the context retrieval model by adjusting parameters to enhance the alignment between the similarity scores of the query 502 and the document 504 to determine the context score 518. Indeed, the contextual query answering system 106 finetunes the context retrieval model based on the context score 518. To illustrate, the contextual query answering system 106 computes a context score 518 (e.g., a cosine-similarity 520) between the output representation 514 (e.g., query embedding) and the output representation 516 (e.g., document embedding). Further, the contextual query answering system 106 finetunes the context retrieval model by comparing the context score 518 to a reference similarity score.

By utilizing the context retrieval model, the contextual query answering system 106 provides a marked improvement over prior systems. For example, in an evaluation of the contextual query answering system 106 utilizing nDCG gain, experimenters demonstrated that the contextual query answering system 106 provides a significant improvement in retrieval quality over a pretrained model (MPNet). Notably, by utilizing nDCG gain as the evaluation metric, the evaluation takes into account not only whether a document is relevant but also the degree of relevance. In particular, the evaluation utilizes relevance numbers from the dataset to assign relevance to one or more relevant documents (each query might have multiple relevant documents). Furthermore, by using nDCG, the evaluation considers the position of relevant documents in the ranked list. The evaluation gives higher scores to relevant documents that appear at the top of the list (which is important since the context retrieval model passes a limited context to the response generator model).

To illustrate, the evaluation reserved rows (approximately 7%) from overall user behavioral data to compare the pretrained model and the contextual query answering system 106. While computing the nDCG metrics, the evaluation also considered all documents in a document set (rather than just the documents in the evaluation batch). Specifically, the evaluation data set contained 47936 rows, as follows:

| | nDCG Pretrained | Contextual Query |
|---|---|---|
| Evaluation Rows | Model (MPnet) | Answering System |
| 47936 | 0.23 | 0.391 |

As shown by the evaluation, the contextual query answering system 106 provides a significant improvement in retrieval quality for both head and tail queries. Two major improvements include domain understanding and the ability to comprehend shorter sentences. For example, the contextual query answering system 106 demonstrates the ability to understand product names and determine an associated relevance. In contrast, the preretrained model confuses Photoshop with Photoshop Express and Premiere Pro with Premiere Rush. In addition, the contextual query answering system 106 demonstrates an ability to comprehend shorter sentences. In particular, the contextual query answering system 106 compensates for user behavior including often typing sentences of fewer than 15 words for a contextual query. As also shown by the evaluation, the contextual query answering system 106 outperforms the pretrained model on shorter sentences.

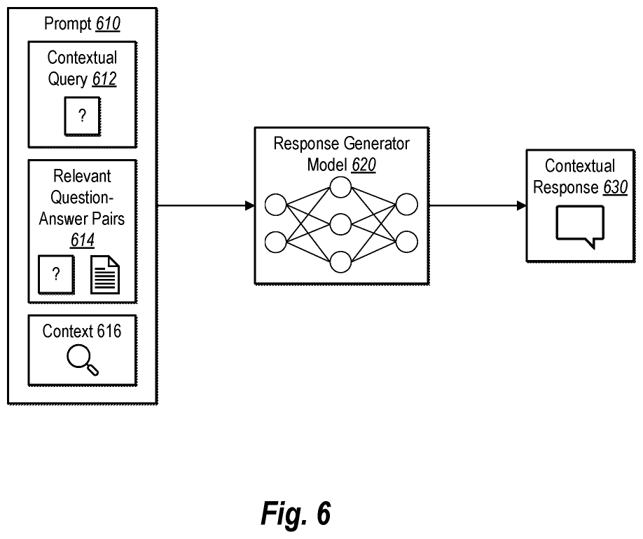

As mentioned, the contextual query answering system 106 provides relevant contextual data to a response generator machine learning model tuned to generate context-specific responses for the software contexts of a plurality of computer applications specific to the software domain at hand. FIG. 6 illustrates utilizing a response generator model to generate a contextual response in accordance with one or more embodiments.

As mentioned, the contextual query answering system 106 provides a prompt 610 to the response generator model 620 to initiate the generation of the contextual response 630. As shown the prompt 610 includes a contextual query 612, relevant question-answer pairs 614, and context 616. The contextual query answering system 106 provides the contextual query 612 that is also utilized by the context retrieval model (as described in relation to FIG. 4A) to the response generator model 620. The contextual query answering system 106 provides the relevant question-answer pairs 614 to the response generator model that are generated by the context retrieval model (as described in relation to FIG. 4A).

In addition, the contextual query answering system 106 provides context 616 including instructions and contextual guidance for providing the contextual response 630. For example, the context 616 includes structure, style, format, restrictions, and/or requirements for the contextual response 630. To illustrate, the response generator model is prompted to answer the contextual query as follows:

Prompt: You are an assistant that helps humans use [PRODUCT NAME, e.g. Adobe
Premiere Pro]. You will be given a list of question-answer pairs (some pairs might be
irrelevant) and a user query. Your goal is to answer the user query using only information
from the given question-answer pairs.
List of question-answer pairs: [. . .]
User query: [. . .]

As mentioned, the response generator model 620 provides step-by-step instructions and/or in-application interaction as part of the contextual response 630. For example, the response generator model 620 provides the contextual response 630 including step-wise instructions with accompanying text explanations. For example, the response generator model 620 provides the contextual response 630 that includes links to instigate in-application interactions to application steps within an associated application. To illustrate, the response generator model 620 provides a contextual response 630 that includes links that, when clicked, trigger interactions within the associated application such as automatically navigating to a different part of the application, prefilling data, opening new tools or windows, or starting certain functions within the application. In this way, the contextual response 630 provides an immersive user experience for complex tasks for applications within the software-specific domain.

In some embodiments, the contextual query answering system 106 accounts for redundant question-answer pairs. In particular, before the relevant question-answer pairs 614 are provided as input to the response generator model 620, the contextual query answering system 106 removes duplicates from the relevant question-answer pairs 614. In certain embodiments, the contextual query answering system 106 computes the Levenshtein distance as well as the semantic similarity between each question/title the of the relevant question-answer pairs 614. If the Levenshtein distance is below a threshold amount for two question-answer pairs (of the relevant question-answer pairs 614), the contextual query answering system 106 computes the semantic similarity between the answers for the two question-answer pairs. If the answers are too semantically similar (e.g., meet a threshold redundancy), the contextual query answering system 106 removes one of the question-answer pairs from the relevant question-answer pairs 614 provided to the response generator model 620. To illustrate, the contextual query answering system 106 removes the question-answer pairs from the relevant question-answer pairs 614 based on redundancy, source credibility, and/or answer length. In some embodiments, the contextual query answering system 106 evaluates the source credibility based on a priority hierarchy of Helpx>Community evaluation>YouTube>LLM-generated QAs.

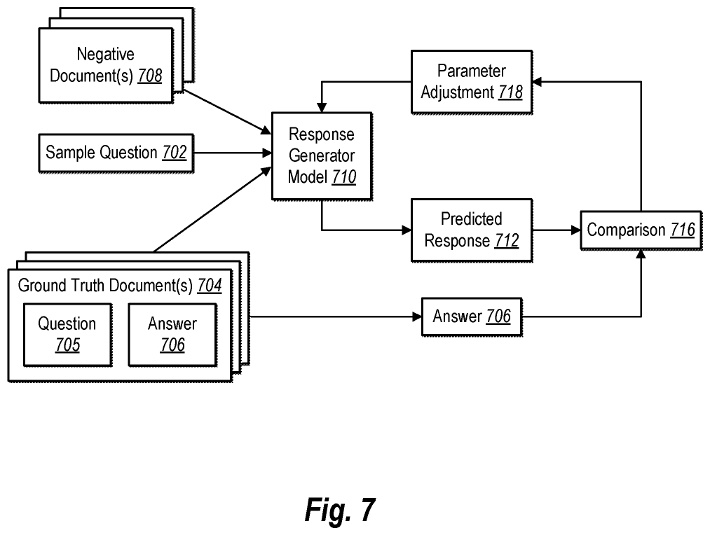

In some embodiments, the contextual query answering system 106 trains the response generator model to generate accurate contextual responses specific to a certain software domain, such as a computer application. FIG. 7 illustrates training a response generator model in accordance with one or more embodiments.

As shown, the contextual query answering system 106 trains the response generator model prompted by a sample question 702, ground truth document(s) 704, and negative document(s) 708. The contextual query answering system 106 retrieves the negative document(s) 708 and the ground truth document(s) 704 from the context retrieval model. As shown, the contextual query answering system 106 utilizes multiple of the negative document(s) 708 and multiple ground truth document(s) 704 and, thus, increases the recall of the retriever components and robustness of the response generator model 710.

In one or more embodiments, the contextual query answering system 106 selects a top-k number of the ground truth document(s) 704 by retrieving documents that are similar to a selected ground truth document in the pre-indexed embedding space. In one or more embodiments, the contextual query answering system 106 selects the ground truth document(s) 704 from among the relevant digital documents. In one or more embodiments, the contextual query answering system 106 filters out ground truth document(s) 704 with answers shorter than a threshold length (e.g., 90 tokens) to provide a training set that instructs the response generator model 710 to generate answers with more comprehensive information. The contextual query answering system 106 generates question-answer pairs (e.g., question 705 and answer 706) for the ground truth document(s) 704 utilizing the context retrieval model tuned based on the stored digital documents as described in relation to FIG. 3.

As shown, the contextual query answering system 106 also trains the response generator model utilizing the negative document(s) 708. In some embodiments, the contextual query answering system 106 determines the negative document(s) 708 based on a random database sampling. In one or more embodiments, the contextual query answering system 106 determines the negative document(s) 708 by selecting digital documents that are within a similarity window or a similarity range in relation to the ground truth document(s) 704. To illustrate, the contextual query answering system 106 selects the negative document(s) 708 such that they satisfy a dis-similarity threshold compared to the ground truth document (e.g., cosine similarity<τₛᵢₘ) and satisfy a similarity threshold compared to the ground truth document (e.g., cosine similarity<τ_{dissim}).

In one or more embodiments, the contextual query answering system 106 provides the response generator model 710 with the input of the negative document(s) 708 and the ground truth document(s) 704 to generate a predicted response 712. Further, the contextual query answering system 106 performs the act 716 to compare the answer 706 with the predicted response 712. During the comparison, the contextual query answering system 106 uses performance metrics to assess how well the predicted response matches the ground truth answer. Based on the comparison, the contextual query answering system 106 performs the act 718 to adjust (or refine) the parameters for the response generator model 710 utilizing a loss function. For example, the contextual query answering system 106 analyzes discrepancies between the predicted response 712 and the answer 706 by performing a comparison to determine patterns in the differences. The contextual query answering system 106 iteratively repeats this process to finetune the response generator model 710 for increasing accuracy (or reduced loss) between predicted responses and ground truth answers over successive iterations.

In one or more embodiments, the contextual query answering system 106 trains the response generator model 710 utilizing only the negative document(s) 708 and no ground truth document(s) 704. In particular, for samples that do not have the ground truth document(s) 704, the contextual query answering system 106 sets the answer 706 to “This question cannot be answered at the moment.” In the same manner as discussed above, the contextual query answering system 106 performs the act 716 to compare the answer 706 with the predicted response 712. Based on the comparison, the contextual query answering system 106 performs the act 718 to adjust (or refine) the parameters for the response generator model 710 utilizing a loss function. By including training with only the negative document(s) 708, the contextual query answering system 106 trains the response generator model to focus more on the knowledge in a document while training.

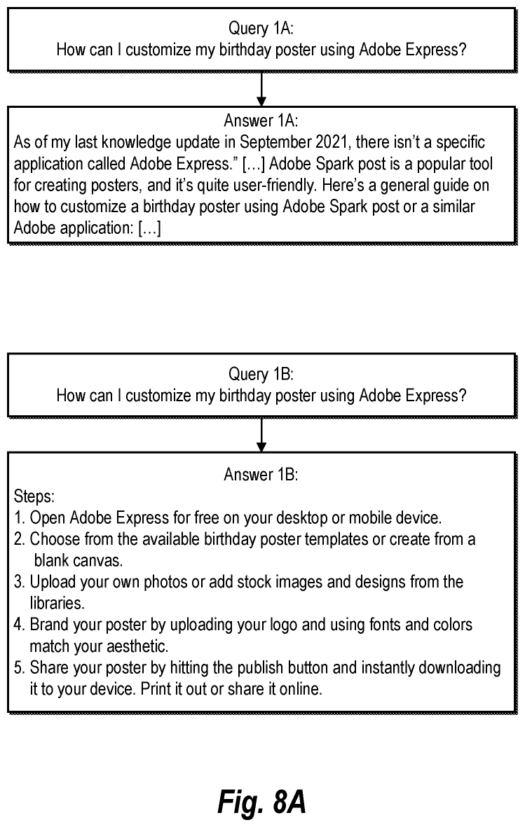

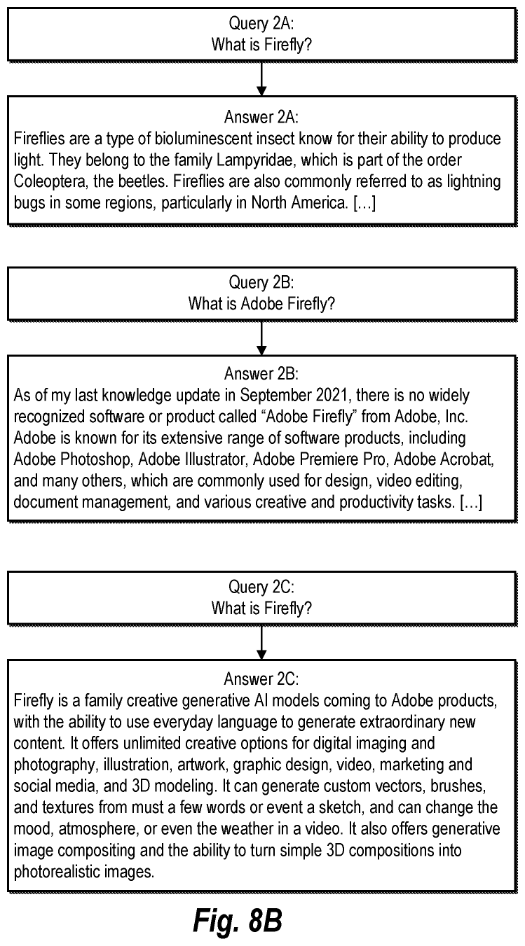

As mentioned, the contextual query answering system 106 provides accurate, actionable contextual responses to software-context-dependent queries. FIGS. 8A-8B illustrate qualitative examples of contextual responses generated from a contextual query in accordance with one or more embodiments.

As shown in FIG. 8A, the contextual query answering system 106 provides superior accuracy and specificity in comparison to general-purpose large language models. To illustrate, as shown by Query 1A and Answer 1A, a sample large language model (of a prior system) trained on a diverse and extensive dataset (spanning over a terabyte of text data), provides a generic and largely unactionable response to the product-specific question: “How can I customize my birthday poster using Adobe Express?” In particular, the sample large language model provides only a “general guide.” In contrast, in answer to the same question as shown by Query 1B and Answer 1B, the contextual query answering system 106 provides a product-specific answer that includes individual steps for customizing the birthday poster using Adobe Express.

As another illustration shown in FIG. 8B, the contextual query answering system 106 is also able to interpret contextual queries with content that could be enigmatic or ambiguous. As shown, the sample large language model is unable to distinguish the context of the capitalized Adobe product “Firefly” within Query 2A: “What is Firefly?” Indeed, the large language model responds with a non-contextual response related to a bug. In addition, the large language model is also unable to provide up-to-date information about “Adobe Firefly” when provided with Query 2B: “What is Adobe Firefly?” Instead, the large language model provides information that is more than 2-years out of date and is about other (different) Adobe products. In contrast, the contextual query answering system 106 provides a response to Query 2C: “What is Firefly?” with an accurate, domain-specific contextual answer specific to the software application Adobe Firefly.

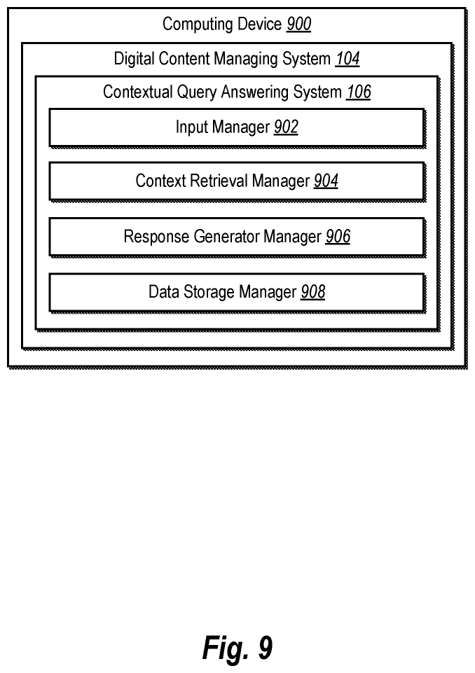

Turning now to FIG. 9, additional detail will now be provided regarding various components and capabilities of the contextual query answering system 106. In particular, FIG. 9 illustrates the contextual query answering system 106 implemented by the computing device 900 (e.g., the server device(s) 102 and/or one of the client device(s) 110 discussed above with reference to FIG. 1). Additionally, the contextual query answering system 106 is also part of the digital content management system 104. As shown in FIG. 9, the contextual query answering system 106 includes, but is not limited to, an input manager 902, a context retrieval manager 904, a response generator manager 906, and a data storage manager 908.

As just mentioned, and as illustrated in FIG. 9, the contextual query answering system 106 includes the input manager 902. In one or more embodiments, the input manager 902 retrieves or determines input comprising a contextual query. Furthermore, the input manager 902 retrieves input that includes stored digital documents (e.g., help documents, community question records, and/or help videos). In addition, the input manager 902 retrieves and manages embeddings for the contextual query and the stored digital documents. For example, the input manager 902 manages query embeddings and data segment embeddings for input to the response generator manager 906.

Additionally, as shown in FIG. 9, the contextual query answering system 106 includes the context retrieval manager 904. The context retrieval manager 904 generates and provides relevant answers as context for the response generator manager 906. For example, the context retrieval manager 904 generates and provides inputs (e.g., a prompt) for the response generator manager 906 utilizing a response generator model.

To illustrate, the context retrieval manager 904 trains and utilizes the context retrieval model to retrieve digital data that corresponds to one or more software applications of a software-specific domain from among stored digital documents that include help documents, community question records, and help videos. As part of determining relevant content, the context retrieval manager 904 generates or extracts data segments (e.g., question-answer pairs, document titles, and/or document descriptions) from the stored digital documents. In one or more embodiments, the context retrieval manager 904 provides the most relevant answers to the response generator model based on evaluating the Levenshtein distance between the data segments, the semantic similarity between the data segments, and/or the data source credibility.

As further shown in FIG. 9, the contextual query answering system 106 includes the response generator manager 906 that trains and utilizes a response generator model. To train the response generator model, the context retrieval manager 904 finetunes the response generator model using training data that includes sample questions, ground truth documents (including a question-answer pair), and negative documents. The context retrieval manager 904 generates and provides the contextual response utilizing the trained response generator model. The response generator manager 906 utilizes relevant answers provided by the context retrieval manager 904 to generate the contextual response.

Additionally, as shown, the contextual query answering system 106 includes data storage manager 908. In particular, data storage manager 908 (implemented by one or more memory devices) stores the digital content used by the contextual query answering system 106 including the digital input, contextual query, embeddings, and contextual responses. The data storage manager 908 facilitates the generation of contextual responses by the contextual query answering system 106.

Each of the components 902-908 of the contextual query answering system 106 includes software, hardware, or both. For example, the components 902-908 include one or more instructions stored on a computer-readable storage medium and executable by processors of one or more computing devices, such as a client device or server device. When executed by the one or more processors, the computer-executable instructions of the contextual query answering system 106 causes the computing device(s) to perform the methods described herein. Alternatively, the components 902-908 include hardware, such as a special-purpose processing device to perform a certain function or group of functions. Alternatively, the components 902-908 of the contextual query answering system 106 include a combination of computer-executable instructions and hardware.

Furthermore, the components 902-908 of the contextual query answering system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 902-908 of the contextual query answering system 106 may be implemented as a stand-alone application, such as a desktop or mobile application. Furthermore, the components 902-908 of the contextual query answering system 106 may be implemented as one or more web-based applications hosted on a remote server. Alternatively, or additionally, the components 902-908 of the contextual query answering system 106 may be implemented in a suite of mobile device applications or “apps.” For example, in one or more embodiments, the contextual query answering system 106 can comprise or operate in connection with digital software applications such as: ADOBE® PHOTOSHOP, ADOBE® PHOTOSHOP ELEMENTS, ADOBE® ILLUSTRATOR, ADOBE® PHOTOSHOP EXPRESS, ADOBE® DOCUMENT CLOUD, ADOBE® PHOTOSHOP EXPRESS, ADOBE® PREMIERE PRO CC, ADOBE® PREMIERE RUSH, ADOBE® AFTER EFFECTS CC, ADOBE® CREATIVE CLOUD, ADOBE® ACROBAT, ADOBE® SIGN, ADOBE® BRIDGE CC, or ADOBE® FIREFLY. The foregoing are either registered trademarks or trademarks of Adobe Inc. in the United States and/or other countries.

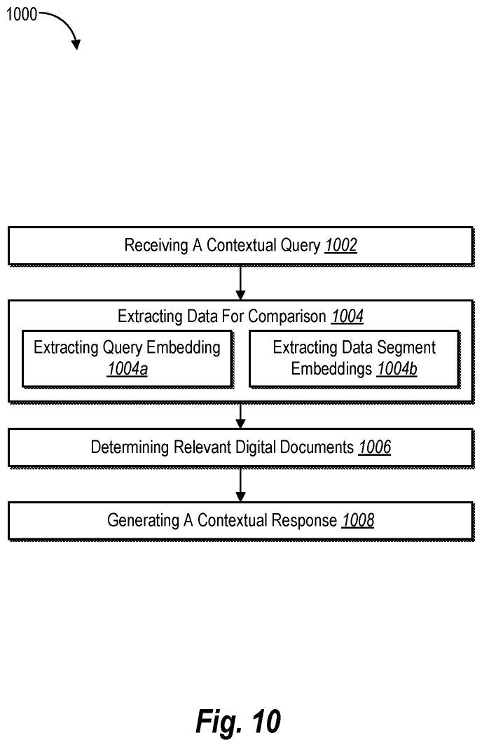

FIGS. 1-9, the corresponding text, and the examples provide a number of different methods, systems, devices, and non-transitory computer-readable media of the contextual query answering system 106. In addition to the foregoing, one or more embodiments can also be described in terms of flowcharts comprising acts for accomplishing a particular result, as shown in FIG. 10. The acts shown in FIG. 10 may be performed in connection with more or fewer acts. Further, the acts may be performed in differing orders. Additionally, the acts described herein may be repeated or performed in parallel with one another or parallel with different instances of the same or similar acts. A non-transitory computer-readable medium can comprise instructions that, when executed by one or more processors, cause a computing device to perform the acts of FIG. 10. In some embodiments, a system can be configured to perform the acts of FIG. 10. Alternatively, the acts of FIG. 10 can be performed as part of a computer-implemented method.

FIG. 10 illustrates a flowchart of a series of acts 1000 for using a contextual query answering system 106 to generate a contextual response in accordance with one or more embodiments. While FIG. 10 illustrates acts according to one embodiment, alternative embodiments may omit, add to, reorder, and/or modify any acts shown in FIG. 10.

FIG. 10 illustrates an example series of acts 1000 for utilizing a contextual query answering system 106 to generate a contextual response. In particular, the series of acts 1000 includes an act 1002 of receiving a contextual query. Specifically, in one or more embodiments, the act 1002 includes receiving a contextual query comprising terminology indicating a software context of a computer application. As illustrated, in some embodiments, the series of acts 1000 also includes an act 1004 with associated sub-act 1004a of extracting query embedding and sub-act 1004b of extracting data segment embeddings. Specifically, in certain embodiments, the act 1004 includes extracting, using a context retrieval model trained to determine relevant contextual data for software contexts of a plurality of computer applications, a query embedding from the contextual query and a plurality of data segment embeddings from data segments of stored digital documents.

As illustrated, in some embodiments, the series of acts 1000 also includes an act 1006 of determining relevant digital documents. Specifically, in one or more embodiments, the act 1006 includes determining, using the context retrieval model, relevant digital documents from among the stored digital documents by comparing the query embedding and the plurality of data segment embeddings. As illustrated, in certain embodiments, the series of acts 1000 also includes an act 1008 of generating a contextual response. Specifically, in one or more embodiments, the act 1008 includes generating, from the relevant digital documents, a contextual response for the contextual query utilizing a response generator model tuned to generate context-specific responses for the software contexts of the plurality of computer applications.

In addition (or in the alternative) to the acts described above, in one or more embodiments, the contextual query answering system series of acts 1000 includes determining a context score for a stored digital document from among the stored digital documents based on comparing the query embedding and the plurality of data segment embeddings. Further, in one or more embodiments, the series of acts 1000 includes selecting the stored digital document as a relevant digital document based on the context score. In addition, in one or more embodiments, the series of acts 1000 includes a contrastive learning model trained to determine, from among help documents, community question records, and help videos, relevant data segments corresponding to the software contexts of the plurality of computer applications.

Furthermore, in one or more embodiments, the series of acts 1000 includes a context retrieval model trained by identifying a set of digital documents selected via client device interaction in relation to a sample query. Additionally, in one or more embodiments, the series of acts 1000 includes a context retrieval model trained by determining, for a sample digital document from among the set of digital documents, a relevance metric in relation to the sample query based on comparing a selection total of the sample digital document and selection totals of other sample documents in the set of digital documents. Moreover, in one or more embodiments, the series of acts 1000 includes a context retrieval model trained by modifying parameters of the context retrieval model using a cross entropy loss function weighted according to the relevance metric.

Additionally, in one or more embodiments, the series of acts 1000 includes determining a relevant answer in relation to the contextual query from among a plurality of question-answer pairs generated utilizing a large language model tuned based on the stored digital documents, wherein the stored digital documents comprise help documents, community question records, and help video transcripts. Further, in one or more embodiments, the series of acts 1000 includes generating the contextual response utilizing the response generator model prompted using the relevant answer and the relevant digital documents.

Furthermore, in one or more embodiments, the series of acts 1000 includes generating a question-answer pair from a ground truth document utilizing a large language model tuned based on the stored digital documents, wherein the stored digital documents comprise help documents, community question records, and help video transcripts. Moreover, in one or more embodiments, the series of acts 1000 includes generating a predicted response for a sample question from the question-answer pair utilizing the response generator model prompted by the sample question, the ground truth document, and a negative document. Additionally, in one or more embodiments, the series of acts 1000 includes refining the parameters based on a comparison of the predicted response to an answer corresponding to the sample question within the question-answer pair.

Moreover, in one or more embodiments, the series of acts 1000 includes generating a negative response for a sample question utilizing the response generator model prompted by the sample question and a negative document, wherein the negative response indicates that no answer is found within the stored digital documents. In addition, in one or more embodiments, the series of acts 1000 includes refining the parameters based on the negative response. Additionally, in one or more embodiments, the series of acts 1000 includes generating, utilizing a context mapping model, a mapping of query terminology from the contextual query to one or more computer applications from among the plurality of computer applications. Furthermore, in one or more embodiments, the series of acts 1000 includes determining the relevant digital documents for the contextual query utilizing the context retrieval model informed by the mapping of query terminology.

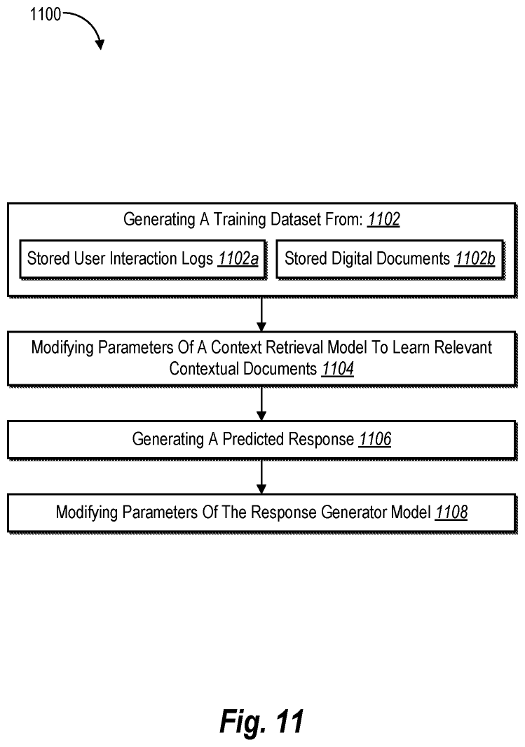

FIG. 11 illustrates a flowchart of a series of acts 1100 for performing operations on a training dataset for contextual query answering system 106 to generate a contextual response in accordance with one or more embodiments. While FIG. 11 illustrates acts according to one embodiment, alternative embodiments may omit, add to, reorder, and/or modify any acts shown in FIG. 11.

FIG. 11 illustrates an example series of acts 1100 for performing operations on a training dataset for contextual query answering system for a contextual query answering system 106 to generate a contextual response. As illustrated, in one or more embodiments, the series of acts 1100 also includes an act 1102 of generating a training dataset with associated sub-act 1102a of generating a training dataset from stored user interaction logs and sub-act 1102b of generating a training dataset from stored digital documents. Moreover, in certain embodiments, the act 1102 includes generating a training dataset from stored user interaction logs and stored digital documents relating to respective software contexts of computer applications.

In addition, in one or more embodiments, the series of acts 1100 also includes an act 1104 of modifying parameters of a context retrieval model to learn relevant digital documents. Specifically, in some embodiments, the act 1104 includes modifying, using contrastive learning on the training dataset, parameters of a context retrieval model to learn relevant digital documents for the respective software contexts of the computer applications. Furthermore, in one or more embodiments, the series of acts 1100 also includes an act 1106 of generating a predicted response. Specifically, in certain embodiments, the act 1106 includes generating, utilizing a response generator model to process a sample query, a predicted response corresponding to the sample query from a ground truth digital document within the relevant digital documents. Moreover, in one or more embodiments, the series of acts 1100 also includes the act 1108 of modifying parameters of the response generator model. Specifically, in some embodiments, the act 1108 includes modifying parameters of the response generator model based on the predicted response to learn context-specific responses for the respective software contexts of the computer applications.

In addition (or in the alternative) to the acts described above, in one or more embodiments, the contextual query answering system series of acts 1100 includes identifying a set of digital documents selected via client device interaction in relation to the sample query. Further, in one or more embodiments, the series of acts 1100 includes determining, for a sample digital document from among the set of digital documents, a relevance metric based on comparing selections of the sample digital document and selections of other sample documents in the set of digital documents. Moreover, in one or more embodiments, the series of acts 1100 includes modifying parameters of the context retrieval model using a cross entropy loss function weighted according to the relevance metric.

Additionally, in one or more embodiments, the series of acts 1100 includes generating question-answer pairs utilizing a large language model to process the stored digital documents, wherein the stored digital documents comprise help documents, community question records, and help video transcripts. Further, in one or more embodiments, the series of acts 1100 includes removing personally identifiable information from the community question records within the stored digital documents. Moreover, in one or more embodiments, the series of acts 1100 includes generating, from the help documents, document summaries comprising titles and descriptions of the help documents.

In addition, in one or more embodiments, the series of acts 1100 includes determining a cosine similarity between a query embedding and a plurality of data segment embeddings extracted from the stored digital documents. Moreover, in one or more embodiments, the series of acts 1100 includes modifying the parameters using a mean squared error function based on the cosine similarity. In addition, in one or more embodiments, the series of acts 1100 includes determining, utilizing a contrastive learning model, a shared weight for a query embedding extracted from the sample query and a plurality of data segment embeddings extracted from data segments of the stored digital documents. Additionally, in one or more embodiments, the series of acts 1100 modifying parameters of the context retrieval model utilizing a loss function informed by the shared weight.

Moreover, in one or more embodiments, the series of acts 1100 includes generating a question-answer pair from a ground truth document utilizing a large language model tuned based on the stored digital documents, wherein the stored digital documents comprise help documents, community question records, and help video transcripts. Further, in one or more embodiments, the series of acts 1100 includes generating a predicted response for a sample question from the question-answer pair utilizing the response generator model prompted by the sample question, the ground truth document, and a negative document. Further, in one or more embodiments, the series of acts 1100 includes updating the parameters of the response generator model based on a comparison of the predicted response to an answer corresponding to the sample question within the question-answer pair.

In addition, in one or more embodiments, the series of acts 1100 includes receiving a contextual query comprising terminology indicating a software context of a computer application. Furthermore, in one or more embodiments, the series of acts 1100 includes extracting, using a context retrieval model trained to determine relevant contextual data for software contexts of a plurality of computer applications: a query embedding from the contextual query; and a plurality of data segment embeddings by determining semantically consistent segments of stored digital documents and extracting embeddings from the semantically consistent segments. Additionally, in one or more embodiments, the series of acts 1100 includes determining, utilizing the context retrieval model, relevant digital documents from among the stored digital documents by comparing the query embedding and the plurality of data segment embeddings. Moreover, in one or more embodiments, the series of acts 1100 includes generating, from the relevant digital documents, a contextual response for the contextual query utilizing a response generator model tuned to generate context-specific responses for the software contexts of the plurality of computer applications.

Further, in one or more embodiments, the series of acts 1100 includes dividing content of the stored digital documents into the semantically consistent segments by determining content portions associated with one or more semantic concepts. Furthermore, in one or more embodiments, the series of acts 1100 includes utilize the context retrieval model to encode a data segment embedding from a semantically consistent segment. Moreover, in one or more embodiments, the series of acts 1100 includes generating the semantically consistent segments by removing personally identifiable information from the stored digital documents utilizing a data sanitization model to replace the personally identifiable information with sanitized text. Additionally, in one or more embodiments, the series of acts 1100 includes extracting the plurality of data segment embeddings by extracting semantically consistent segments from: primary sources comprising document summaries of help documents; and derived sources comprising question-answer pairs generated from help videos and community question records.

Moreover, in one or more embodiments, the series of acts 1100 includes determining a set of question-answer pairs utilizing a large language model to process the stored digital documents, wherein the stored digital documents comprise help documents, community question records, and help video transcripts. In addition, in one or more embodiments, the series of acts 1100 includes generating, from the set of question-answer pairs, a subset of question-answer pairs by removing redundant question-answer pairs using a Levenshtein distance. Additionally, in one or more embodiments, the series of acts 1100 includes generating the contextual response utilizing the response generator model informed by the subset of question-answer pairs.

Furthermore, in one or more embodiments, the series of acts 1100 includes identifying a set of digital documents selected via client device interaction in relation to a sample query. Moreover, in one or more embodiments, the series of acts 1100 includes determining, for a sample digital document from among the set of digital documents, a relevance metric in relation to the sample query based on comparing a selection total of the sample digital document and selection totals of other sample documents in the set of digital documents. In addition, in one or more embodiments, the series of acts 1100 includes modifying parameters of the context retrieval model using a cross entropy loss function weighted according to the relevance metric.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 12 illustrates a block diagram of an example computing device that may be configured to perform one or more of the processes described above. One will appreciate that one or more computing devices, such as the computing device 1200 may represent the computing devices described above (e.g., server device(s) 102, client device(s) 110, and computing device 1200). In one or more embodiments, the computing device 1200 may be a mobile device (e.g., a mobile telephone, a smartphone, a PDA, a tablet, a laptop, a camera, a tracker, a watch, a wearable device, etc.). In some embodiments, the computing device 1200 may be a non-mobile device (e.g., a desktop computer or another type of client device). Further, the computing device 1200 may be a server device that includes cloud-based processing and storage capabilities.

As shown in FIG. 12, the computing device 1200 can include one or more processor(s) 1202, memory 1204, a storage device 1206, input/output interfaces 1208 (or “I/O interfaces 1208”), and a communication interface 1210, which may be communicatively coupled by way of a communication infrastructure (e.g., bus 1212). While the computing device 1200 is shown in FIG. 12, the components illustrated in FIG. 12 are not intended to be limiting. Additional or alternative components may be used in other embodiments. Furthermore, in certain embodiments, the computing device 1200 includes fewer components than those shown in FIG. 12. Components of the computing device 1200 shown in FIG. 12 will now be described in additional detail.

In particular embodiments, the processor(s) 1202 includes hardware for executing instructions, such as those making up a computer program. As an example, and not by way of limitation, to execute instructions, the processor(s) 1202 may retrieve (or fetch) the instructions from an internal register, an internal cache, memory 1204, or a storage device 1206 and decode and execute them.

The computing device 1200 includes memory 1204, which is coupled to the processor(s) 1202. The memory 1204 may be used for storing data, metadata, and programs for execution by the processor(s). The memory 1204 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1204 may be internal or distributed memory.

The computing device 1200 includes a storage device 1206 includes storage for storing data or instructions. As an example, and not by way of limitation, the storage device 1206 can include a non-transitory storage medium described above. The storage device 1206 may include a hard disk drive (HDD), flash memory, a Universal Serial Bus (USB) drive or a combination these or other storage devices.

As shown, the computing device 1200 includes one or more I/O interfaces 1208, which are provided to allow a user to provide input to (such as user strokes), receive output from, and otherwise transfer data to and from the computing device 1200. These I/O interfaces 1208 may include a mouse, keypad or a keyboard, a touch screen, camera, optical scanner, network interface, modem, other known I/O devices or a combination of such I/O interfaces 1208. The touch screen may be activated with a stylus or a finger.

The I/O interfaces 1208 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1208 are configured to provide graphical data to a display for presentation to a user. The graphical data may be representative of one or more graphical user interfaces and/or any other graphical content as may serve a particular embodiment.

The computing device 1200 can further include a communication interface 1210. The communication interface 1210 can include hardware, software, or both. The communication interface 1210 provides one or more interfaces for communication (such as, for example, packet-based communication) between the computing device and one or more other computing devices or one or more networks. As an example, and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI. The computing device 1200 can further include a bus 1212. The bus 1212 can include hardware, software, or both that connects components of computing device 1200 to each other.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A computer-implemented method comprising:
receiving a contextual query comprising terminology indicating a software context of a computer application;
extracting, using a context retrieval model trained to determine relevant contextual data for software contexts of a plurality of computer applications, a query embedding from the contextual query and a plurality of data segment embeddings from data segments of stored digital documents;
determining, using the context retrieval model, relevant digital documents from among the stored digital documents by comparing the query embedding and the plurality of data segment embeddings; and
generating, from the relevant digital documents, a contextual response for the contextual query utilizing a response generator model tuned to generate context-specific responses for the software contexts of the plurality of computer applications.

2. The computer-implemented method of claim 1, wherein determining the relevant digital documents comprises:
determining a context score for a stored digital document from among the stored digital documents based on comparing the query embedding and the plurality of data segment embeddings; and
selecting the stored digital document as a relevant digital document based on the context score.

3. The computer-implemented method of claim 1, wherein the context retrieval model is a contrastive learning model trained to determine, from among help documents, community question records, and help video transcripts, relevant data segments corresponding to the software contexts of the plurality of computer applications.

4. The computer-implemented method of claim 1, wherein the context retrieval model is trained by:
identifying a set of digital documents associated with client device interaction in relation to a sample query;
determining, for a sample digital document from among the set of digital documents, a relevance metric in relation to the sample query based on comparing a selection total of the sample digital document and selection totals of other sample documents in the set of digital documents; and
modifying parameters of the context retrieval model using a cross entropy loss function weighted according to the relevance metric.

5. The computer-implemented method of claim 1, further comprising:
determining a relevant question-answer pair in relation to the contextual query from among a plurality of question-answer pairs generated utilizing a large language model tuned based on the stored digital documents, wherein the stored digital documents comprise help documents, community question records, and help video transcripts; and
generating the contextual response utilizing the response generator model prompted using the relevant question-answer pair.

6. The computer-implemented method of claim 1, wherein the response generator model comprises parameters learned by:
generating a question-answer pair from a ground truth document utilizing a large language model tuned based on the stored digital documents, wherein the stored digital documents comprise help documents, community question records, and help video transcripts;
generating a predicted response for a sample question from the question-answer pair utilizing the response generator model prompted by the sample question, the ground truth document, and a negative document; and
refining the parameters based on a comparison of the predicted response to an answer corresponding to the sample question within the question-answer pair.

7. The computer-implemented method of claim 1, wherein the response generator model comprises parameters learned by:
generating a negative response for a sample question utilizing the response generator model prompted by the sample question and a negative document, wherein the negative response indicates that no answer is found within the stored digital documents; and
refining the parameters based on the negative response.

8. The computer-implemented method of claim 1, further comprising:
generating, utilizing a context mapping model, a mapping of query terminology from the contextual query to one or more computer applications from among the plurality of computer applications; and
determining the relevant digital documents for the contextual query utilizing the context retrieval model informed by the mapping of query terminology.

9. A non-transitory computer readable medium storing executable instructions which, when executed by a processing device, cause the processing device to perform operations comprising:
generating a training dataset from stored user interaction logs and stored digital documents relating to respective software contexts of computer applications;
modifying, using contrastive learning on the training dataset, parameters of a context retrieval model to learn relevant digital documents for the respective software contexts of the computer applications;
generating, utilizing a response generator model to process a sample query, a predicted response corresponding to the sample query from a ground truth digital document within the relevant digital documents; and
modifying parameters of the response generator model based on the predicted response to learn context-specific responses for the respective software contexts of the computer applications.

10. The non-transitory computer readable medium of claim 9, wherein the operations further comprise:
identifying a set of digital documents associated with client device interaction in relation to the sample query;
determining, for a sample digital document from among the set of digital documents, a relevance metric based on comparing selections of the sample digital document and selections of other sample documents in the set of digital documents; and
modifying parameters of the context retrieval model using a cross entropy loss function weighted according to the relevance metric.

11. The non-transitory computer readable medium of claim 9, wherein generating the training dataset comprises:
generating question-answer pairs utilizing a large language model to process the stored digital documents, wherein the stored digital documents comprise help documents, community question records, and help video transcripts;
removing personally identifiable information from the community question records within the stored digital documents; and
generating, from the help documents, document summaries comprising titles and descriptions of the help documents.

12. The non-transitory computer readable medium of claim 9, wherein modifying the parameters of the context retrieval model comprises:
determining a cosine similarity between a query embedding and a plurality of data segment embeddings extracted from the stored digital documents; and
modifying the parameters using a mean squared error function based on the cosine similarity.

13. The non-transitory computer readable medium of claim 9, wherein the operations further comprise:
determining, utilizing a contrastive learning model, a shared weight for a query embedding extracted from the sample query and a plurality of data segment embeddings extracted from data segments of the stored digital documents; and
modifying parameters of the context retrieval model utilizing a loss function informed by the shared weight.

14. The non-transitory computer readable medium of claim 9, wherein modifying the parameters of the response generator model comprises:
generating a question-answer pair from a ground truth document utilizing a large language model tuned based on the stored digital documents, wherein the stored digital documents comprise help documents, community question records, and help video transcripts;
generating a predicted response for a sample question from the question-answer pair utilizing the response generator model prompted by the sample question, the ground truth document, and a negative document; and
updating the parameters of the response generator model based on a comparison of the predicted response to an answer corresponding to the sample question within the question-answer pair.

15. A system comprising:
one or more memory devices; and
one or more processors coupled to the one or more memory devices, the one or more processors configured to cause the system to:
receive a contextual query comprising terminology indicating a software context of a computer application;
extract, using a context retrieval model trained to determine relevant contextual data for software contexts of a plurality of computer applications:
a query embedding from the contextual query; and
a plurality of data segment embeddings by determining semantically consistent segments of stored digital documents and extracting embeddings from the semantically consistent segments;
determine, utilizing the context retrieval model, relevant digital documents from among the stored digital documents by comparing the query embedding and the plurality of data segment embeddings; and
generate, from the relevant digital documents, a contextual response for the contextual query utilizing a response generator model tuned to generate context-specific responses for the software contexts of the plurality of computer applications.

16. The system of claim 15, wherein the one or more processors are further configured to cause the system to extract the plurality of data segment embeddings by:
dividing content of the stored digital documents into the semantically consistent segments by determining content portions associated with one or more semantic concepts; and
utilize the context retrieval model to encode a data segment embedding from a semantically consistent segment.

17. The system of claim 15, wherein the one or more processors are further configured to cause the system to generate the semantically consistent segments by removing personally identifiable information from the stored digital documents utilizing a named entity removal model to replace the personally identifiable information with sanitized text.

18. The system of claim 15, wherein the one or more processors are further configured to cause the system to extract the plurality of data segment embeddings by extracting semantically consistent segments from:
primary sources comprising document summaries of help documents; and
derived sources comprising question-answer pairs generated from help videos and community question records.

19. The system of claim 15, wherein the one or more processors are further configured to cause the system to:
determine a set of question-answer pairs utilizing a large language model to process the stored digital documents, wherein the stored digital documents comprise help documents, community question records, and help video transcripts;
generate, from the set of question-answer pairs, a subset of question-answer pairs by removing redundant question-answer pairs using a Levenshtein distance; and
generate the contextual response utilizing the response generator model informed by the subset of question-answer pairs.

20. The system of claim 15, wherein the context retrieval model is trained by:
identifying a set of digital documents selected via client device interaction in relation to a sample query;
determining, for a sample digital document from among the set of digital documents, a relevance metric in relation to the sample query based on comparing a selection total of the sample digital document and selection totals of other sample documents in the set of digital documents; and
modifying parameters of the context retrieval model using a cross entropy loss function weighted according to the relevance metric.
